(19) United States
(12) Patent Application Publication
(10) Pub. No.: US 2012/0286691 A1
(43) Pub. Date: Nov. 15, 2012

(54) Method, Apparatus, and System for Supplying Pulsed Current to a Load

(75) Inventor: Ronald D. Jesme, Plymouth, MN (US)

(73) Assignee: 3M Innovative Properties Company, Saint Paul, MN (US)

(21) Appl. No.: 13/519,251

(22) PCT Filed: Dec. 21, 2010
(86) PCT No.: PCT/US10/61582

§ 371 Date: Jun. 26, 2012

Related U.S. Application Data
(60) Provisional application No. 61/292,305, filed on Jan. 5, 2010.

(51) Int. Cl. G05F 1/10; H05B 37/00

(52) U.S. Cl. 315/250; 323/282; 323/284

(57) ABSTRACT

Supplying pulsed current to a load involves repeatedly driving an electrical load between successive active and idle states via a regulator that includes a switched mode power supply. The regulator receives input current from a direct current power source and provides output current to at least an energy storage device in the idle states of the electrical load. The energy storage device is coupled to the load and the regulator. Output current is provided from both the regulator and the energy storage device to the electrical load in the active states of the electrical load. A storage capacity of the energy storage device is selected so that a duty cycle of the input current is greater than a duty cycle of the output current.

### TECHNICAL FIELD

This specification relates in general to electronic devices, and more particularly to systems, apparatuses, and methods for supplying pulsed current to a load.

### BACKGROUND

The demand for mobile computing devices has been steadily increasing for the last few decades. A mobile computing device may include any general- or special-purpose data processing device that is capable of operating portably, typically using a portable power source such as batteries, solar cells, fuel cells, etc. The large majority of mobile devices are capable of operating on batteries for at least some amount of time, and power management of battery-powered devices is a constant challenge.

Examples of portable devices include smart phones, personal digital assistants, gaming consoles, media players, cameras, etc. Each of these types of device may have particular characteristics related to usage patterns, available power sources, customer expectations, etc., that need to be taken into account when designing power management hardware and software. One type of mobile device that looks to become increasingly popular is known as a pico projector. The term “pico projector” generally refers to a portable video device that can project video onto a viewable surface such as a wall or screen.

Producers of pico projectors are focusing on devices that are small, low-cost, bright, and consume little power. Such projectors may have self-contained functionality (e.g., can play videos directly from computer readable media) and/or act as a peripheral device that can complement other mobile devices (e.g., smartphones, laptop computers). As a result, pico projectors may offer valuable new capabilities and applications to the rapidly growing mobile device market.

Small, low-cost, bright, and low-power pico projectors may use light emitting diodes (LEDs) to produce the video output. Using LEDs for pico projector illumination provides some advantages, including mechanical simplicity, reliability, relatively low power consumption, and relatively low cost. However, there is still room for improvement in the performance of LEDs in this type of application. For example, such devices often run on battery power, and therefore may benefit from improvements to energy efficiency of the projection device.

### SUMMARY

The present disclosure relates to systems, apparatuses, computer programs, data structures, and methods for supplying pulsed current to an electrical load. In one embodiment, an apparatus includes a regulator that has a switched mode power supply. A power input of the regulator is capable of being coupled to receive input current from a direct current power source, and a power output of the regulator is capable of being coupled to an electrical load that draws pulsed current from the regulator. The apparatus includes an energy storage device coupled to the power output of the regulator. A storage capacity of the energy storage device is selected so that a duty cycle of the input current is greater than a duty cycle of the pulsed current.

In more particular embodiments of the apparatus, the storage capacity of the energy storage device may be selected so that the current duty cycle of the direct current power source approximates a constant current draw. The apparatus may further include a feedback circuit coupled at least to the power input. The feedback circuit modifies a current drawn by the electrical load based on a determination that a duty cycle of the direct current power source meets a predefined threshold. In one configuration, the feedback circuit increases the current drawn by the electrical load based on a determination that the current duty cycle of the direct current power source falls below a predefined threshold. In such a case, the feedback circuit may increase the current drawn by the electrical load by increasing the duty cycle of the pulsed current and/or increase the current drawn by the electrical load by increasing a peak current drawn by the electrical load. In another configuration, the feedback circuit decreases the input current based on a determination that the duty cycle of the direct current power source falls below a predefined threshold.

In other more particular embodiments, the apparatus may further include a protection circuit that limits maximum energy storage of the energy storage device. In one arrangement, the electrical load may include a driver for one or more pulsed light emitting diodes. In another arrangement, the regulator may include a DC-to-DC voltage boost converter. In such a case, the energy storage device may include a capacitor that is selected to have an equivalent series resistance less than a product of an internal resistance of the power source and a voltage gain of the DC-to-DC voltage boost converter squared.

In other more particular embodiments, the direct current power source may include any combination of a battery and a universal serial bus. In one arrangement, the energy storage device may include a capacitor, and the capacitor is selected to have an equivalent series resistance less than an internal resistance of the direct current power source. In another arrangement, the apparatus may include the direct current power source.

In another embodiment of the invention, a method involves repeatedly driving an electrical load between successive active and idle states via a regulator that includes a switched mode power supply. The regulator receives input current from a direct current power source and provides output current to at least an energy storage device in the idle states of the electrical load. The energy storage device is coupled to the load and the regulator. Output current is provided from both the regulator and the energy storage device to the electrical load in the active states of the electrical load. A storage capacity of the energy storage device is selected so that a duty cycle of the input current is greater than a duty cycle of the output current.

In another embodiment of the invention, an apparatus one or more driver circuits configured to provide pulsed on and off current to light emitting diodes according to an output duty cycle. The apparatus includes a switched mode, regulator capable of receiving input current from a direct current power source and including a power output coupled to the one or more driver circuits to provide the pulsed on and off current. An energy storage device is coupled to the power output of the regulator so that the energy storage device stores energy during at least an idle state of the output duty cycle. A storage capacity of the energy storage device is selected so that a duty cycle of the input current is greater than the output duty cycle.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### BRIEF DESCRIPTION OF THE DRAWINGS

The invention is described in connection with example embodiments illustrated in the following diagrams.

FIG. 1 is a block diagram of a system according to an example embodiment of the invention;

FIGS. 2 and 3 are graphs comparing current and power dissipated between different configurations according to an example embodiment of the invention;

FIG. 4 is a circuit diagram illustrating a power management circuit according to an example embodiment of the invention;

FIGS. 5 and 6 are circuit diagrams of an apparatus according to an example embodiment of the invention;

FIG. 7A is a graph representing voltages and currents seen in a circuit simulation using the circuits described in FIGS. 5 and 6 according to an example embodiment of the invention;

FIG. 7B is a graph representing voltages and currents seen in a circuit simulation using the circuits described in FIG. 6 and a modified version of FIG. 6;

FIG. 8 is a circuit diagram showing a feedback circuit according to an example embodiment of the invention;

FIG. 9 is a circuit diagram showing an alternate feedback circuit according to an example embodiment of the invention;

FIG. 10 is a block diagram showing an apparatus according to an example embodiment of the invention; and

FIG. 11 is a flowchart illustrating a method according to an example embodiment of the invention.

### DETAILED DESCRIPTION

In the following description of various example embodiments, reference is made to the accompanying drawings that form a part hereof, and in which is shown by way of illustration various example embodiments. It is to be understood that other embodiments may be utilized, as structural and operational changes may be made without departing from the scope of the present invention.

The present invention is generally related to systems, methods, and apparatuses that provide improved power management for devices requiring a pulsed electrical load. By way of example and not of limitation, this invention is described in the context of power management of projecting devices that utilize light emitting diodes (LEDs) for illumination. Embodiments described herein can improve the performance of battery-powered and Universal Serial Bus (USB) powered projector devices, or any other device having a significant portion of the power budget dedicated to a pulsed current electrical load.

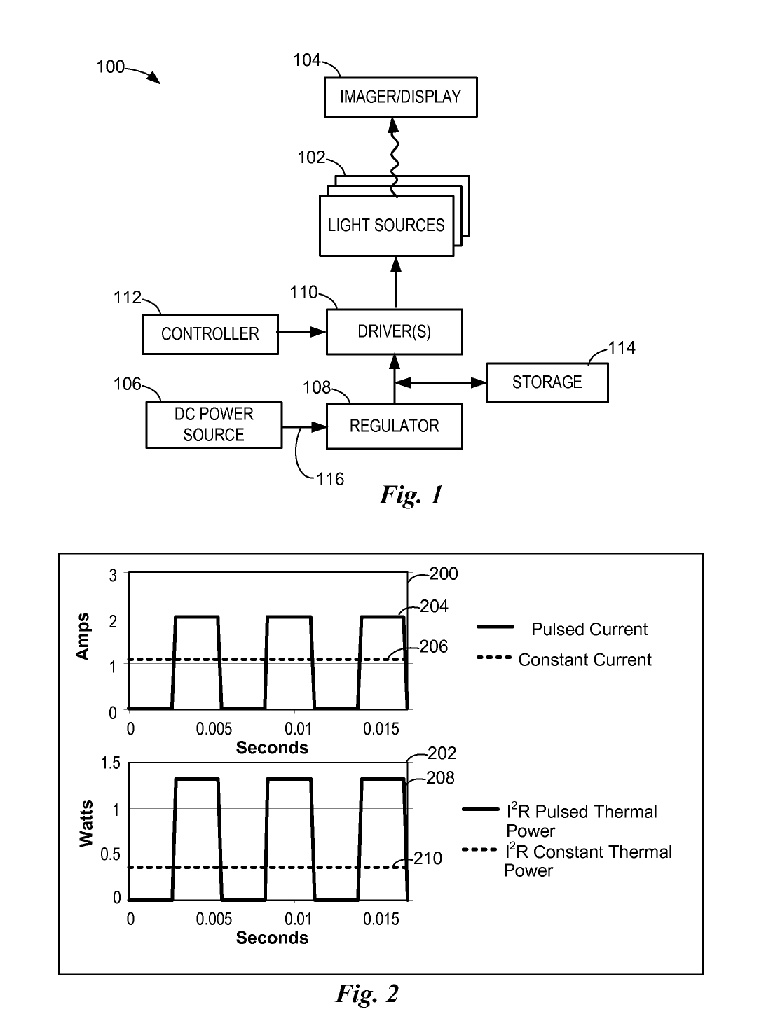

In reference now to FIG. 1, a block diagram illustrates a system 100 according to an example embodiment of the invention. The system 100 includes one or more independently activated light sources 102. Each of the light sources 102 may emit at different wavelengths from each other. For example, the system 100 may utilize color sequential projection to produce video output via the light sources 102.

Color sequential projection refers to the forming of each frame of a full-color video image using sequentially projected fields (or planes), each field representing a different (e.g., primary) color. The fields are projected fast enough in sequence so that the human eye combines the fields to perceive a full-color image for each video frame. In the examples that follow, the light sources such as 102 may described as LEDs, although the example embodiments may be applicable to other light sources, including incandescent, fluorescent, and/or any other current or future electroluminescence technology. The system may include any number of color fields and light sources 102. For example, three light sources (red, green, and blue) may each illuminate during one or more of three color fields.

The system includes an imager/display 104 that causes particular elements (e.g., pixels) to be illuminated for each color field. Example imagers 104 include liquid crystal on silicon (LCoS) spatial light modulators (SLMs) and micromirror reflectors. In projection systems, the light sources 102 project light through/via imager 104 where it is projected onto a suitable viewing surface. This may generally involve synchronizing the operations of the imager 104 and light sources 102.

The system 100 may be partially- or fully-powered by a direct current (DC) power source 106. This DC power source 106 may be internal or external to the system 100. Examples of internal power sources include batteries (e.g., lithium, nickel metal hydride, alkaline, nickel cadmium), solar cells, fuel cells, mechanical generators, etc. Examples of external power sources include USB ports/cables, inductive power transfer, external versions of the internal supplies (e.g., battery packs, solar chargers), etc. As will be described in greater hereinbelow, the example embodiments include features that can minimize energy losses from the DC power source 106. Such energy losses include current dissipated as heat before it is delivered to the light sources 102 and intermediary components.

The system 100 may include a regulator 108 (e.g., voltage regulator) that couples the DC power source 106 to the light sources 102, e.g. via driver circuitry 110. The driver circuitry 110 provides a high level of control of the light sources 102, such as via signals received from a controller 112. The controller 112 may include logic circuitry for driving the light sources 102 in synchronization with other devices (e.g., the display/imager 104) and may facilitate other adjustments to the system, such as brightness, color balance, color modes, etc.

In a sequential color imaging system, the controller 112 may be configured to at least activate the light sources 102 during time-separated (e.g., sequential) color fields that collectively form a color sequential image (e.g., video frame). When activated, the light sources 102 emit light that can be received by the imager 104. The imager 104 may include features configured to receive light from the light sources 102 and use the received light to selectively illuminate pixels on a display during each of the color fields.

For example, the imager 104 may cause only a selected subset of pixels to display for each color field. Such selective display of pixels by the imager 104 may be accomplished in a binary manner, e.g., either on or off for a particular pixel, or in a variable manner, e.g., causing each pixel to project the light in discrete or continuous range from off (no illumination) to on (fully illuminated). Each pixel of these imaging devices 104 may be individually addressable so that digital logic can form full color images based on interactions between the imager 104, the controller 112, and the light sources 102.

A state of the imager 104 is continually changed as each color field transitions to the next for each image frame. The imager 104 may be in an indeterminate state during these transition times, and so it may be necessary to switch off the light sources 102 so as not to introduce unwanted artifacts into the projected image. In order to achieve this, the controller 112 and drivers 110 may pulse the light sources 102 using a current waveform such as square wave.

A color sequential image generation system may require relatively large pulses of power to drive the light sources 102, interspaced with times where relatively little power is required. Pulsed currents may result in significant thermal power losses in resistances through which these currents flow. While these currents may need to be pulsed through the resistance of the light sources 102, it may not be necessary to pulse these currents through the internal impedance of the DC power source 106.

In the case of DC power sources 106 having a well-defined maximum allowable current draw (e.g., battery or a USB port), it can be advantageous to constantly extract energy at or near the maximum allowed rate and store this energy, e.g., using a storage device 114. The storage device 114 is coupled in the circuit to alternatively store and discharge energy at a point where an output of the regulator 108 is coupled to a primary electrical load. In this example, the electrical load may include at least the light sources 102.

Energy stored in the device 114 can enable large current pulses to be delivered to the light sources 102 that might otherwise exceed the maximum allowable current draw of the power source 106. This reduces the peak current drawn from the DC power source 106 via path 116, and may smooth and/or increase the duty cycle of the current waveform leaving the power source 106 via path 116.

The term “duty cycle” as generally used herein refers to a fraction of time that the power source is providing a proportionally high amount of current. For example, if the power source 106 is delivering a time-average current of one amp at 100% duty cycle, then the current waveform would resemble a flat line at one amp. For the same time-averaged, one amp current at 50% duty cycle, the current waveform might resemble a square wave with equal “on” and “off” times, and the current level would be two amps during the “on” time, and at or near zero at the “off” times.

It will be appreciated that, when drawing energy from the power source 106, there may be benefits in approximating a constant current draw, e.g., at or near to a 100% duty cycle. Reducing peak current drawn by increasing the duty cycle of the power source 106 reduces thermal losses due to internal resistance of the power source 106. The rate of these thermal losses (in watts) can be expressed by the formula I²R, where I is the current level in amps and R is the internal resistance in ohms of the power source 106.

Referring again to the previous example of 100% duty cycle versus 50% duty cycle, if the internal resistance of the power source 106 were 1 ohm, then for a 100% duty cycle, the energy lost due to internal resistance for a time X drawing a time average one amp would be (1 amp)²(1 ohm)(X seconds)=X joules. For a 50% duty cycle (assuming that the time X is much larger than the square wave frequency of the power output) the thermal losses would be approximately (2 amps)²(1 ohm)(0.5 X seconds)=2X joules. Therefore in this theoretical case, there is a 50% reduction in thermal losses by using a 100% duty cycle instead of 50% duty cycle for the same, time-average, current draw.

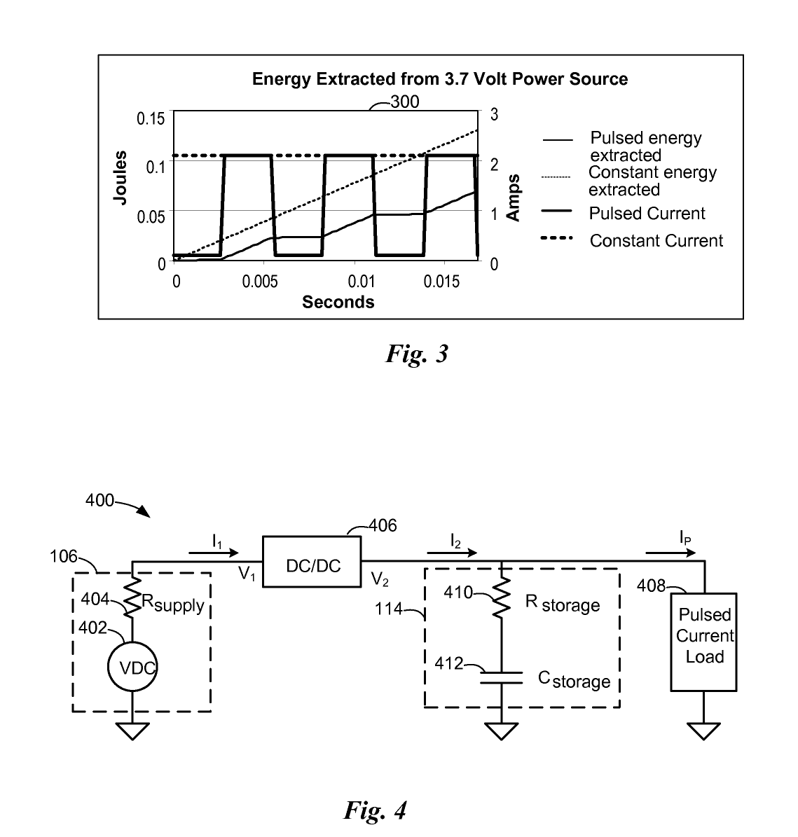

In FIGS. 2 and 3, graphs 200, 202, and 300 further depict advantages of constant current from a power source 106 according to embodiments of the invention. The graph 200 shows two current wave forms and graph 202 shows the resulting thermal power loss (I²R) through a 0.3 ohm internal resistance of a power source 106. In graph 200, a pulsed current waveform 204 is switched between 0.1 amp and 2.1 amp at a 50% duty cycle. The 0.1 amp level of waveform 204 represents the current draw from the source needed to power ancillary circuitry, and the 2.1 amp level represents the current drawn from the source needed to power ancillary circuitry plus the LEDs used to illuminate a color field. The other current wave form 206 is a constant current of 1.1 amp. Both of these current waveforms have a time average value of 1.1 amp.

If it is assumed that both of these current waveforms 204, 206 represent current drawn from a given voltage source, then both represent equal average power drawn from the voltage source. However if, for example, this power is delivered through a 0.3 ohm resistance (such as the internal resistance of a battery and/or resistance of power management circuitry and/or resistance of DC/DC converters), then the power dissipated in the form of heat by this resistance is P=I²R, where P is power, I is current, and R is resistance.

The two waveforms 208, 210 in graph 202 are I²R waveforms, where I² is the current squared from waveforms 204, 206, respectively, and R is 0.3 ohms In the case of the pulsed current, the average thermal power produced (represented by power waveform 208) is 0.663 watt, but only 0.363 watt for the case of constant current (represented by power waveform 210). This thermal power may be considered as waste power, and may also have the adverse effect of heating up components (e.g., lithium batteries and/or optical films) beyond specified operating temperatures. From this example it can be seen that it can be advantageous to draw current in a continuous rather than pulsed manner because less power is diverted to produce waste thermal energy for an equal amount of power drawn from the source, leaving more of the power available for delivery to the intended load, e.g., LEDs.

In the case of a battery or USB port that has a specified maximum allowable current draw, it can be advantageous to constantly extract energy at or near the maximum allowed/recommended rate and store this maximum available energy to enable large energy pulses to be delivered to the LEDs that may otherwise exceed the maximum allowable current draw from the power source. The graph 300 in FIG. 3 shows that more joules of energy can be drawn from a power source if drawn continuously at maximum current as opposed to drawing the maximum current periodically. Specifically the graph 300 shows that if energy is pulled from a voltage source at a constant current of 2.1 amp then about 0.13 joule of energy can be drawn from a 3.7 volt source in 1/60 of a second, while only about 0.07 joules of energy can be drawn from a 3.7 volt source in 1/60 second if the current alternates between 0.1 amp and 2.1 amp at a 50% duty cycle as in FIG. 3. To make best use of the power continuously drawn from a voltage source, some of the energy can be stored in a capacitor to be used as needed.

If drawing power constantly from a source, it is possible that energy could be stored at a rate greater than that at which, on average, it is expended. In this case it may be useful to limit or interrupt the energy extraction and storage process once a specific energy storage limit has been reached. If a capacitor is being used to store the extracted energy, for example, the energy storage limit could be considered to have been reached when a specific capacitor voltage threshold has been reached. From this example it can be seen that the maximum power may be extracted by continuously extracting power at the maximum allowable rate.

Referring again to FIG. 1, in an apparatus such as a projector, output lumens of the light sources 102 and battery life are both performance parameters by which such apparatus may be assessed. The embodiments shown and described herein provide a practical approach to maximize both of these parameters when powered by current limited sources 106 such as lithium batteries and USB ports. This may be achieved by extracting all available power while minimizing thermal losses in the power sources 106.

In some embodiments, the improved apparatuses can deliver 25% to 100% more power to the light sources 102. In such a case, the light sources 102 may be LEDs operating with LCoS imagers 104 that support 50% to 80% illumination duty cycles. These battery or USB-powered apparatuses may exhibit improved efficiency in transferring power from power source 106 to LEDs 102, such as where a current-controlled regulator 108 drives pulsed LEDs 102 in a color sequential display.

It may also be useful to have circuitry that can detect when a maximum safe energy storage capacity of storage device 114 has been reached, to ensure that circuit components are not driven beyond their specified ratings. Once this maximum storage capacity has been reached, continued energy draw from the power source 106 could be discontinued until the energy stored at device 114 falls below the storage capacity limit.

The storage device 114 may include any type of electronic capacitor known in the art. Capacitors of differing construction and capacities may be selected to provide numerous functions (e.g., filtering, phase shifting of AC signals, etc.). In the case of the present storage device 114, the capacitors may be selected to store sufficient amounts of energy to substantially increase the duty cycle of the DC power source 106, and thereby reduce losses due to internal resistance. How much duty cycle increase is considered “substantial” may vary based on numerous design factors, including the incremental costs of increasing capacity of the power source 106, cost and space required for adding storage device 114 versus increased market value of the system 100 due to advantages of increased brightness, increased battery life, long term battery reliability, etc. In one embodiment, is contemplated that one useful design point of the system 100 is be to reduce peak-to-peak variation of about 30% of the RMS or average value of current draw.

Given a well-defined target duty cycle of the DC power source 106, one of ordinary skill in the art can select appropriate capacitors to provide energy storage of device 114. Such considerations may further be based on the current usage profile of the pulsed light sources 102 under various conditions, the characteristics of the power source 106 and regulator 108, power draw of other system components, etc. Improvements in capacitor technology result in the increasing availability of components for this purpose having reduced the size and cost for a given energy storage capacity. Examples of energy storage capacitors suitable for this purpose are shown in Table 1 below. Multiple capacitors can be connected in parallel to increase the total capacitance and reduce the total effective series resistance (ESR).

TABLE 1
Storage Capacitors

| | | | | | Size: |
|---|---|---|---|---|---|
| | | Capaci- | | Voltage | L, W, |
| Mfgr | Part Number | tance | ESR | Rating | H, mm |
| Vishay | 597D108X9010F2T | 1 mF | 120 mΩ | 10 v | 7.3, 6.0, |
| | | | | | 4.7 |
| AVX | TLN6158M010R0055 | 1.5 mF | 55 mΩ | 10 v | 14.5, |
| | | | | | 7.5, 2.0 |

In reference now to FIG. 4, circuit diagram 400 illustrates specific examples of circuit components according to an example embodiment of the invention. As in FIG. 1, FIG. 4 includes a DC power source 106 that may be represented as a voltage source 402 and an internal resistance 404. A DC/DC boost converter 406 is acting as a regulator in this circuit 400. A boost converter is a type of DC/DC converter where the output voltage (V2) is greater than the input voltage (V1).

This type of converter 406 can be designed to draw a continuous input current of approximately constant magnitude, thus providing a means of extracting energy at an approximately constant rate, assuming that the input voltage V1 is approximately constant. For example, the output voltage of a USB port is approximately constant when operating within the limits of the USB specification. The output voltage of many battery types is approximately constant within some range of current draw. Thus a boost converter 406 can be used to extract energy from a power source 106 such as a battery or USB port at approximately a constant rate, and is used in the following examples

The output of the boost converter 406 is coupled to both the storage device 114 and a pulsed current load 408. The storage device 114 is modeled here as an ideal capacitor 412 in series with a resistance 410 that makes up the ESR of the device 114. The pulsed current load 408 may be any electrical device that draws current in a pulsed manner, e.g., in a pattern generally resembling a square wave. In the case of an LED-based color sequential system such as shown in FIG. 1, the power may be delivered to light sources 102 in a pulsed manner. To do this with high efficiency, energy can be drawn from the power source 106 at a constant current and stored in the capacitor 412 with a low internal resistance (effective series resistance) 410 to keep the storage-related losses low.

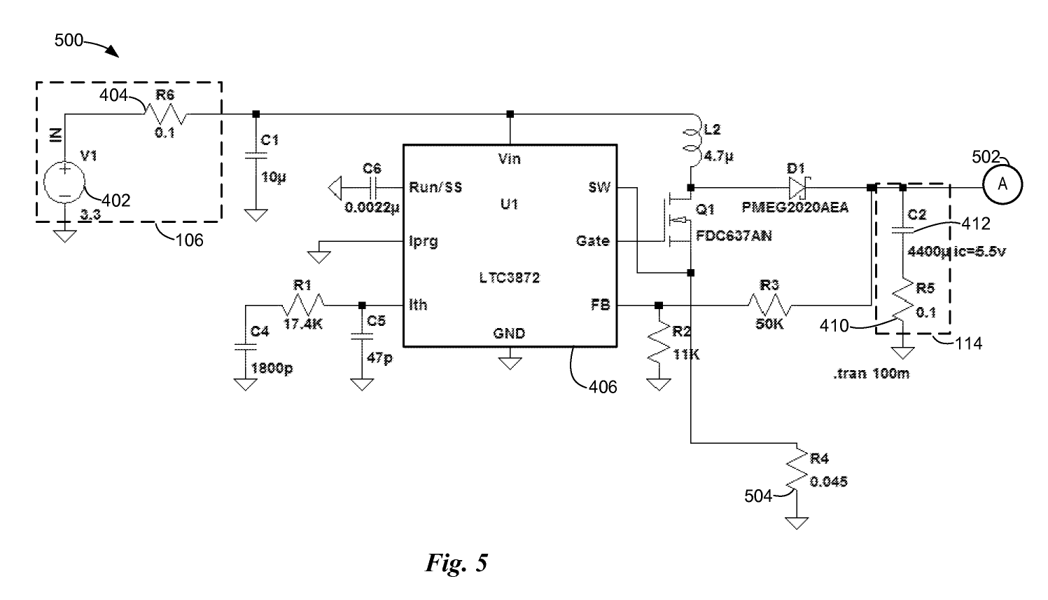

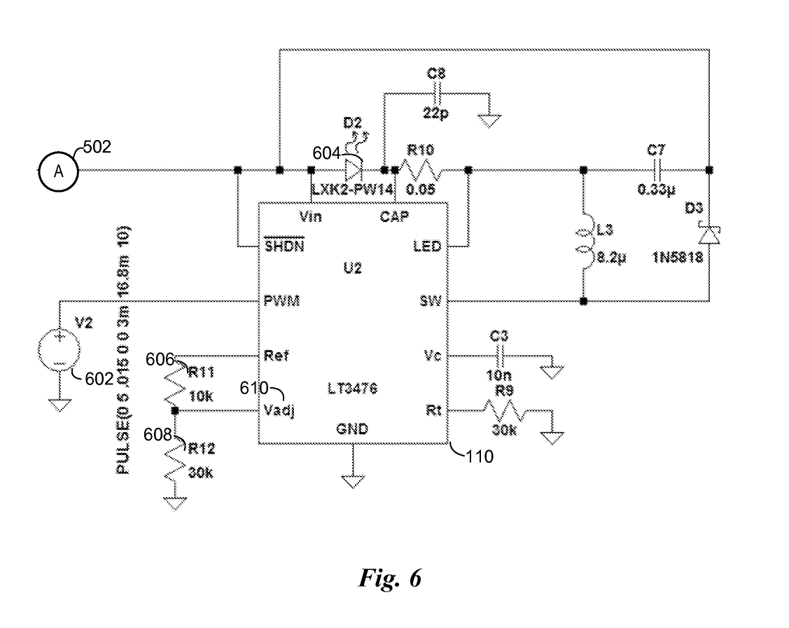

To gain a better understanding of the present invention, a more detailed example is shown in the circuit diagrams of FIGS. 5 and 6, where like reference numbers may be used to refer to analogous components shown in FIGS. 1 and 4. The diagram in FIG. 5, shows power management circuitry 500 of a simulated LED projector system. The circuitry 500 includes DC power source 106, storage device 114, and boost converter 406. The illustrated boost converter is a LTC3872 constant frequency, current mode boost DC/DC controller made by Linear Technology, Corp. The remainder of the components of the circuit 500 can be chosen based on the specifications of the boost converter 406 and the desired power output characteristics. The circuit 500 is coupled to a pulsed electrical load via node 502, which is continued in FIG. 6.

In FIG. 6, a circuit diagram 600 shows one of three LED drive circuits that may receive pulsed current from the power management circuitry 500 via node 502. Generally, for the purposes of the simulation discussed below, the system may include three circuits substantially similar to circuit 600, all of them being coupled in parallel to node 502. These circuits 600 may cause LEDs 604 to be independently pulsed by logic circuits, which are represented here as input voltage sources 602. As will be shown below, each of the three circuits 600 may separately pulsed via signals 602 input to one channel of an LT3476 driver 110 manufactured by Linear Technology Corp. The LT3476 is a quad output, DC/DC converter designed to operate as a constant-current source for driving high current LEDs.

Each channel of the four-channel driver 110 may illuminate a different colored LED 604 during at least one color field. By way of example and not of limitation, the simulation uses three color fields, each field illuminated by respective green, red, and blue LEDs. In the simulation, each LED 604 is illuminated separately. However, as will be discussed in greater detail below, the input signals 602 may be programmably altered so that two or more of the LEDs 604 may simultaneously illuminate during a given color field. This may be the result of user selectable modes that, for example, provide increased brightness. As will also be described below, the power management circuitry 500 may include features to adjust the current flow in circuits 500, 600 based on these additional modes.

These circuits 500, 600 may include, among other things, 1) a circuit for controlling the continuous or near-continuous extraction of energy from a power source at the maximum available/allowable current, 2) an energy storage capacitor, 3) a protection circuit limiting the maximum energy storage, 4) a circuit to deliver pulsed current to a load, such as one or more LEDs 604. This system enables an LED based color sequential system to pull the maximum power from a current limited power source 106, e.g., a lithium battery or USB port, to provide the maximum available power to the illumination LEDs 604 for improved brightness. Further, drawing energy at a constant rate, as opposed to large periodic pulses, can reduce the heat generated in the internal impedance of the power source, reducing the temperature of the power source while also increasing the efficiency of energy transfer from the power source to the LEDs 604.

For purposes of the simulation, the power supply 106 shown in FIG. 5 is configured as a lithium battery with voltage source 402 as the battery voltage and resistor 404 as the internal resistance of this battery. The energy storage device 114 has a capacitance represented as capacitor 412 and effective series resistance (ESR) represented by resistor 410. The remainder of the circuitry 500 provides the constant current draw of about two amps from the battery 106, as well as the max energy storage sensing and control to interrupt the continuous current draw when the max storage level is sensed on storage capacitor 412. The circuits 500, 600 provide pulsed currents to three LEDs, represented here as LED 604. Each LED 604 provides one of a pulsed green, red and blue light to illuminate a color sequential display.

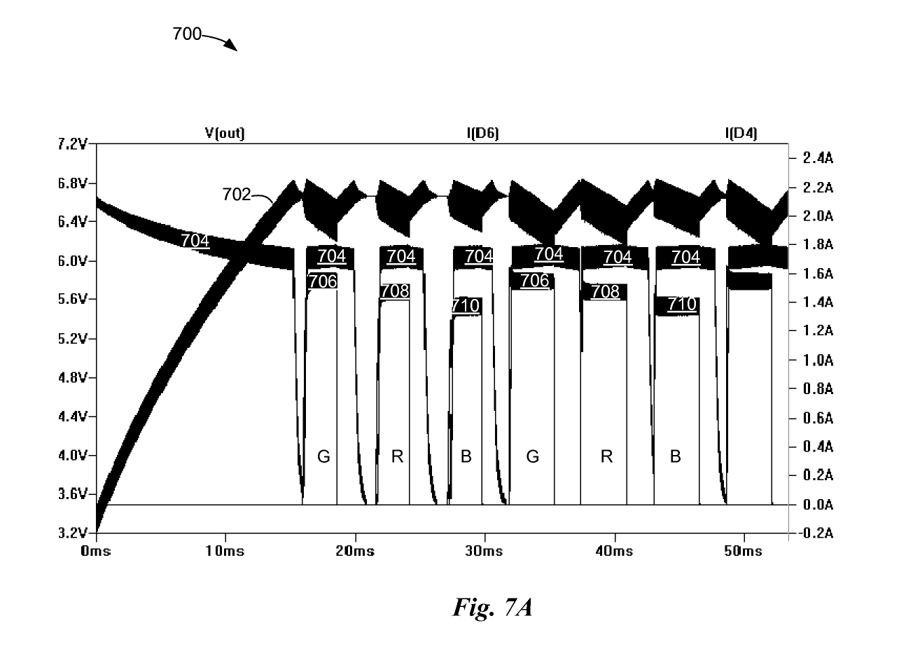

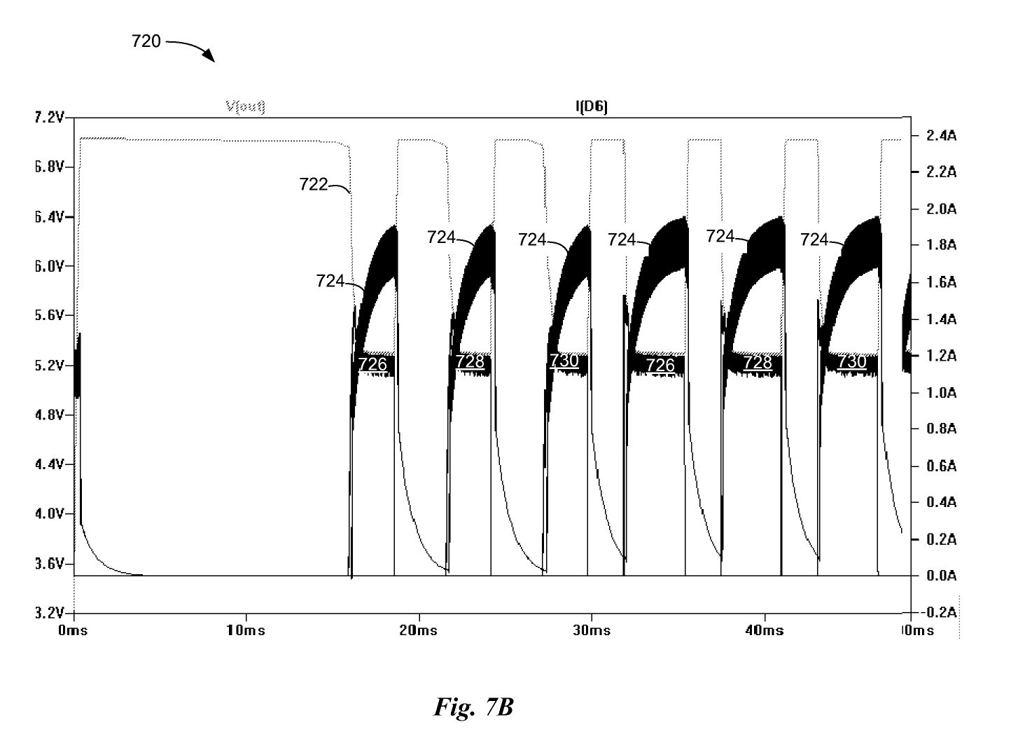

In reference now to FIG. 7A, a graph 700 represents respective voltages and currents seen in the circuit simulation using the circuits 500 and 600 described above. The graph 700 includes respective current pulses 706, 708, and 710 which respectively cause illumination of the green, red and blue LEDs. The voltage of storage capacitor 412 in FIG. 5 is represented by the trace 702. The current from power source 106 is represented by the trace 704, which includes multiple reference markings to distinguish the pulse train from LED current pulses 706, 708, and 710. Pulses 706, 708, and 710 are enabled the logic voltage sources 602 and used to control the timing of the green, red and blue LED current pulses.

It should be noted that in the simulation, the circuitry does not approach steady state operation until after about 33 ms. Prior to this time, LT3476 circuits are reaching a proper bias point; all subsequent pulses are properly produced. In this example, the current draw 704 from the power source 106 (through resistor 404) is approximately 1.7 amp peak, with a steady state duty cycle of about 85%. It can be seen by inspection of graph 700 that the duty cycle of curve 704 is greater than the composite duty cycle of the pulses 706, 708, and 710 (e.g., about 60-65% duty cycle). Without the energy storage device 114, the current draw curve would more closely resemble the composite of the pulses 706, 708, and 710.

Also of note in FIG. 7A is that at time=0, the voltage 702 is equal to the battery voltage. During the initial 15 ms, it can be seen that voltage 702 is increasing with a nearly constant slope. This is because storage capacitor 412 is being charged with a nearly constant battery current of approximately two amps (the battery current in this simulation is limited to approximately 2 amps). The voltage curve 702 has constant upward and downward slopes, indicating constant charge and discharge currents. The capacitor energy storage is limited by controlling the maximum voltage to about 6 volts.

The voltage curve 702 droops during the green LED current pulses 706 because this current pulse draws energy from the storage capacitor 412 at a rate greater than that at which energy is being provided to the storage capacitor 412 by the boost converter 406. In contrast, the voltage 702 is approximately flat during the blue LED current pulses 710, indicating that the energy being drawn from the storage capacitor 412 during the blue pulse is about equal to the rate at which energy is being provided to the storage capacitor 412 by the boost converter 406. The magnitude of the green, red and blue current pulses 706, 708, 710 are not equal in these simulations, nor is it necessary that they will be equal in practice, given the wide variety of power efficiencies, wavelengths, etc., of the projecting LEDs 604. Other factors such as color tuning and different operating modes of the projecting device may also affect these magnitudes.

Instead of placing the energy storage device 114 as shown in FIG. 5, a conventional approach is to place a large capacitor in parallel with the battery, e.g., power source 106. Another simulation was run with a modified version of the circuit 500, where the location of C1 and storage device 114 (capacitor 412 with ESR 410) were swapped from what is shown in FIG. 5. The resulting circuit performance is shown at graph 720 in FIG. 7B. The graph 720 includes current/voltage measurements 722, 724, 726, 728, and 730 that are analogous to corresponding traces 702, 704, 706, 708, and 710 in FIG. 7A.

As can be seen in FIG. 7B, this conventional placement of a storage capacitor at the power source 106 does not perform well. The voltage curve 722 droops so low that the LED current pulses are below the design magnitudes seen in FIG. 7A. The current flow 724 resembles current pulses, not a constant current draw. This is due to the maximum current draw being limited to about two amps by R4 (504). Additional simulations still exhibit this current pulsing even if R4 (504) is changed to increase the maximum current draw to about three amps. In such a case, the amplitude of the LED current pulses are restored, but the current draw from the battery still appears as current pulses. This is also still the case when the ESR of the relocated storage device 114 is reduced by two orders of magnitude to 0.001 ohms

Other simulations of these modified circuit show that increasing capacity of the storage capacitor by a factor of 10 reduces the ripple of the current drawn from the battery (e.g., 724) from a peak-to-peak value of about 2.7 amps to about 0.8 amps, approaching a continuous current draw of about 1.7 amps. To obtain a nearly continuous steady-state current draw of about 1.7 amps in the modified circuit, the storage capacitor must be increased by another factor of ten to 440 mF (equivalent to 1004 mF 0.1 ohm ESR capacitors in parallel). This reduces the ripple of the current drawn from the battery to only 0.2 amps peak-to-peak. This is comparable to the performance of the circuit in FIG. 5, however requires a tenfold increase in capacity of the storage capacitor to achieve this result.

These circuit simulations show that, in a given application, a continuous current draw from the battery can be achieved with a smaller storage capacitor if the capacitor is connected to the battery via a constant current circuit rather than connected directly to the battery. The smaller capacitance as shown in the circuit of FIG. 5 may be preferred in some situations because the smaller capacitance value of the storage capacitor results in less expense and a smaller physical size—both important in the mobile device market.

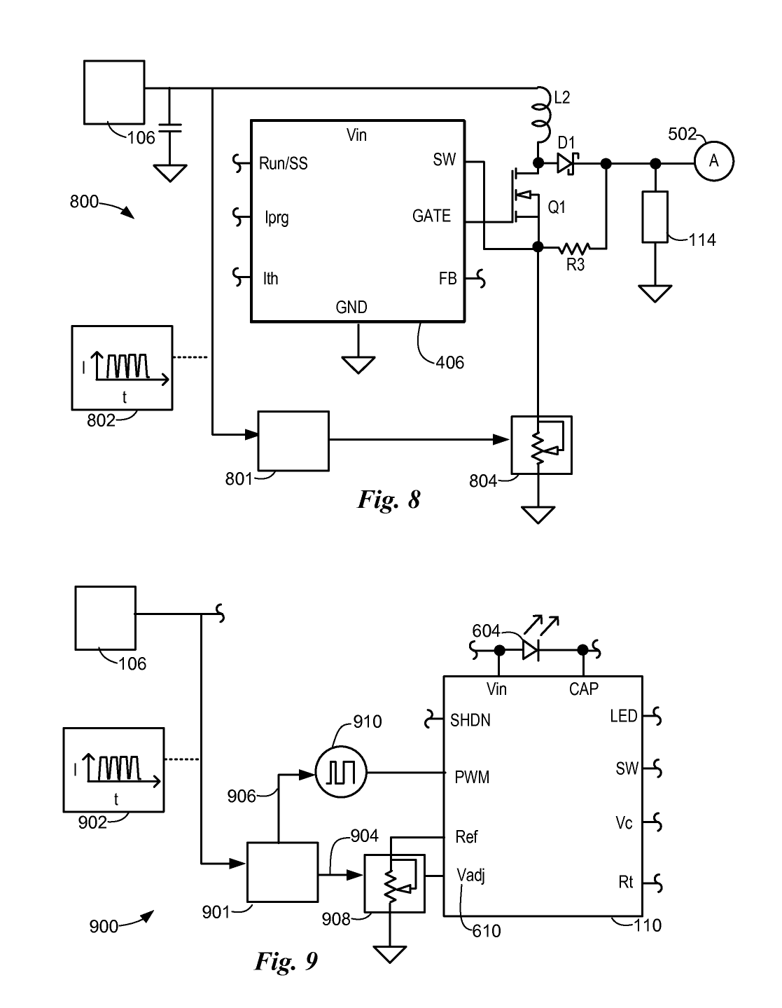

It may be possible to increase the duty cycle of the power source 106 even further than is illustrated in the simulation results of FIG. 7A. For example, it may be possible to choose circuit components (e.g., capacitance 412 and ESR 410 of storage device 114) such that curve 704 approximate a 100% duty cycle (e.g., constant current draw) during steady state operation under many operating conditions. In another embodiment, a feedback loop could detect that the draw from the battery is not at or near 100% duty cycle, and as a result reduce the amplitude of the current draw, e.g., by increasing LED drive current. This is seen in FIG. 8, which is a simplified schematic showing a duty cycle adjustment feedback circuit 800 according to an example embodiment of the invention.

The circuit 800 interfaces with DC power source 106 and boost converter 406 such as are shown and described in relation to FIG. 5. Other components and interconnections shown in FIG. 5 have been removed from the diagram of FIG. 8 for clarity. A feedback component 801 measures duty cycle of current output from the power source 106 as indicated by graph 802. The component 801 may include an analog or digital circuitry for estimating the current duty cycle 802. The duty cycle 802 can be estimated, for example, by analyzing a shunt voltage using digital sampling, analog integrator, etc. The output of the component 801 causes respective modification of a resistance and/or voltage at component 804. Component 804 replaces fixed resistor 504 shown in FIG. 5, which sets the current draw magnitude of the boost converter 406. Thus, when the duty cycle 802 falls below a certain value, this can be detected by component 801. In response, the component may decrease current draw of the boost converter by way of adjusting component 804.

Another duty cycle adjustment feedback circuit 900 according to an example embodiment of the invention is shown in the simplified schematic of FIG. 9. The circuit 900 interfaces with DC power source 106 and driver 110 such as are shown and described in relation to FIGS. 5 and 6. Other components and interconnections shown in FIGS. 5 and 6 have been removed from the diagram of FIG. 9 for clarity.

A feedback component 901 measures duty cycle of current output from the power source 106 as indicated by graph 902. The component 901 determine duty cycle 902 in any way such as described above in regards to component 801 of FIG. 8. Component 901 has two outputs 904, 906, which may be implemented together or separately from each other.

Output 904 of component 901 causes respective modification of a resistance and/or voltage at component 908. Component 908 replaces one or both of fixed resistors 606, 608 shown in FIG. 6. These resistors 606, 608 can be selected to set the voltage at V_{adj} 610. It should be noted that the multiple ones of component 908 may be set at each channel of a multi-channel driver such as the LT3476. Modification of V_{adj} 610 modifies the drive current of the respective LEDs 604 of each channel. Thus, when the duty cycle 902 falls below a certain value, this can be detected by component 901. In response, the component 901 may increase current draw of the LED 604 by way of adjusting component 908.

Output 906 can be used to and/or increase the pulse duty cycle provided to the LEDs 604, as represented by variable pulse width voltage source 910. The pulse widths provided to the LEDs 604 by source 910 can independently vary the duty cycle of the digital logic pulses supplied to the driver 110. The component 910 that receives input 906 may be a device that initiates/triggers the pulses (e.g., imager 104 in FIG. 1). In another embodiment, component 910 may be an intermediary that increases/decreases pulse width of pulses that originate elsewhere (e.g., from imager 104 in FIG. 1). In either case, it will be appreciated that varying the illumination time of the LEDs 604 by modifying digital logic pulse width can increase or decrease the time average current drawn by the LEDs 604, and therefore increase duty cycle of the DC power source 106.

Generally, where an apparatus has a relatively constant and well-defined power consumption profile, a cost-benefit analysis may determine whether feedback circuits such as shown in FIGS. 8 and 9 are necessary and/or desirable. However, where the load may vary widely, then feedback circuits may be worth any added cost and complexity in order to provide benefits described herein, such as improving battery efficiency. For example, an apparatus may have selectable color modes where two or more light sources 102 illuminate simultaneously during some color fields. This may provide, for example, a brighter picture at the expense of reduced color gamut. The ability to alter modes may cause significantly variance in the pulsed current needed to drive the light sources, and such a device may benefit from power feedback circuits. For a better understanding these different color modes, reference is made to concurrently filed, commonly-owned U.S. Patent Application (Attorney Docket Number 65827US002) entitled “Method, Apparatus, And System For Color Sequential Imaging,” which is hereby incorporated by reference in its entirety.

In another scenario, an apparatus may be able to receive power from multiple sources, e.g., USB, internal battery, external power brick, etc. These power sources may have substantially different characteristics, such as internal resistance, maximum allowable current draw, etc. In such a case, the feedback circuits such as shown in FIGS. 8 and 9 may be able to tailor the profile to provide optimal power transfer efficiency based on the particular source of power.

In reference again to FIG. 4, a mathematical analysis follows that describes performance aspects of a power supply arrangement according to embodiments of the invention. A first analysis examines battery resistance 404 versus ESR 410 of a storage device 114. As discussed above (e.g., in regards to FIG. 7B), existing approaches may involve coupling a storage capacitor directly to the output of the power source 106. In such a case, a pulsed load 408 will in turn draw a pulsed current from the supply 106, causing heat dissipation through the internal resistance 404 of the supply.

The first part of the analysis assumes a circuit as in FIG. 4 except without the storage device 114. In this first part of the analysis, the values (e.g., voltage V₁) are appended with the “prime” symbol (′) in order to differentiate from second part of the analysis where the circuit includes the storage device 114. In the first part, the power P1′ entering the converter 406 the power P2′ leaving the converter 406 are:

P₁′=I₁′V₁′ (1)

P₂′=I₂′V₂′ (2)

Assuming a very highly efficient DC/DC converter, the power into such a converter may be approximated as being equal to the power leaving the converter. Thus P₁′=P₂′ and:

I₁′V₁′=I₂′V₂′ (3)

Defining the pulsed load current duty cycle to be D, where D is between 0 and 1, then the power P_{supply} dissipated by R_{supply} is:

P_{supply′}=(I₁′)²R_{supply′}D (4)

Combining equations (3) and (4) yields an equivalent equation:

P_{supply}′=(I₂′)²(V₂′/V₁′)²R_{supply}′D (5)

This represents the total waste power of the circuit of FIG. 4 without the storage device 114. The circuit of FIG. 4 is next evaluated with the storage device 114 included. In this case, it is assumed that I₁ and I₂ are constant and C_{storage} is charged to a steady state voltage. A practical storage capacitor may have an associated ESR, represented as R_{storage} in FIG. 4. If this ESR is large then the associated power loss may overwhelm the potential advantage of a storage capacitor. Power is lost in the ESR due to I²R thermal loss during the charging and discharging cycles of the storage capacitor. The capacitor will be discharged during duty cycle D, and charged during duty cycle 1−D. The charge current is I₂ for duty cycle 1−D, and the discharge current is I_{P}−I₂ for a fractional duration of D. The power loss P_{ESR} due to the ESR during one complete charge and discharge cycle is:

P_{ESR}=I₂²R_{storage}(1−D)+(I_{P}−I₂)²R_{storage}D (6)

Given a net charge balance, the integrated charge current I₂ from the converter for duration 1−D plus the integrated current 1₂ supplied by the converter to the load for duration D will equal the integrated load current I_{P} for duration D, thus:

I₂(1−D)+I₂D=I_{P}D (7)

I₂[(1−D)+D]=I_{P}D (7a)

I₂[1−D+D]=I_{P}D (7b)

Solving for I₂ in equation (7b) results in:

I₂=I_{P}D (8)

Substituting the result of equation (8) result into equation (6) results in:

P_{ESR}=I_{P}²D²R_{storage}(1−D)+(I_{P}−I_{P}D)²R_{storage}D (9)

P_{ESR}=I_{P}²D²R_{storage}(1−D)+[I_{P}(1−D)]²R_{storage}D (9a)

P_{ESR}=I_{P}²D²R_{storage}(1−D)+I_{P}²(1−D)²R_{storage}D (9b)

The total waste power of the circuit of FIG. 4 is the power dissipated by the ESR plus the power dissipated by the R_{storage}, for a total of:

I_{P}²D²R_{storage}(1−D)+I_{P}²(1−D)²R_{storage}D+I₂²(V₂/V₁)²R_{supply} (9c)

Substituting equation (8) in expression (9c) results in:

I_{P}²D²R_{storage}(1−D)+I_{P}²(1−D)²R_{storage}D+(I_{P}D)²(V₂/V₁)²R_{supply} (9d)

Expression (9d) can be rearranged as:

I_{P}²D²R_{storage}(1−D)+I_{P}²(1−D)²R_{storage}D+I_{P}²D²(V₂/V₁)²R_{supply} (10)

For the power dissipation of the circuit of FIG. 4 with the storage device 114 to be less than the circuit of FIG. 4 without the storage device 114, then equation (10) will be less than equation (5), and the following will result:

I_{P}²D²R_{storage}(1−D)+I_{P}²(1−D)²R_{storage}D+I_{P}²D²(V₂/V₁)²R_{supply}≦(I_{P}′)²(V₂/V₁′)²R_{supply}D (11)

For a fair comparison, the following is also assumed to be true:

V₂/V₁=V₂′/V₁′, I_{P}=Iₙ′, and R_{supply}=R_{supply}′ (12)

Solving the inequality in (11) using the equalities in (12) results in (12a) below, which is further reduced in (12b)-(12g) and (13) below:

I_{P}²D²R_{storage}(1−D)+I_{P}²(1−D)²R_{storage}D+I_{P}²D²(V₂/V₁)²R_{supply}≦I_{P}²(V₂/V₁)²R_{supply}D (12a)

DR_{storage}(1−D)+(1−D)²R_{storage}+D(V₂/V₁)²R_{supply}≦(V₂/V₁)²R_{supply} (12b)

R_{storage}[(1−D)D+(1−D)²]≦(V₂/V₁)²R_{supply}(1−D) (12c)

R_{storage}[(D−D²)+(1−2D+D²)]≦(V₂/V₁)²R_{supply}(1−D) (12d)

R_{storage}[D−D²+1−2D+D²]≦(V₂/V₁)²R_{supply}(1−D) (12e)

R_{storage}(1−D)≦(V₂/V₁)²R_{supply}(1−D) (12f)

R_{storage}(V₂/V₁)²R_{supply} (12g)

R_{storage}R_{supply}(V₂/V₁)² (13)

Thus when equation (13) is true, the thermal power dissipation of the circuit of FIG. 4 with the storage device 114 is less than the power dissipation of the circuit without the storage device 114. In other words, for capacitors with sufficiently small ESR, a storage capacitor can improve the power available to pulse the LEDs. This is particularly advantageous in the case of a boost converter, because in that case V₂/V₁ is greater than one. In such a case, even if the ESR of the storage capacitor is not significantly less than the internal resistance of the power supply, this may still be offset by the (V₂/V₁)² term.

A similar analysis is next discussed which looks at USB duty cycle versus ESR 410 of the storage device 114. Again, a first analysis models the circuit in FIG. 4 without the storage device 114 using the prime symbol to designate variables. In such a case, the pulsed load 408 in turn draws a pulsed current from an external current limited supply 106, such as a battery or USB port. The power P1′ entering the converter 406 and the power P₂′ leaving the converter are:

P₁′=I₁′V₁′ (14)

P₂′=I₂′V₂′ (15)

Assuming a very highly efficient DC/DC converter, the power into such a converter can be assumed equal to the power leaving the converter. Thus:

P₁′=P₂′, and, I₁′V₁′=I₂′V₂′ (16)

Also note that, without the storage device 114, the following may also be assumed to be true:

I₂′=I_{P}′ (17)

Defining the pulsed load current duty cycle to be D, where D is between 0 and 1, then the power P_{P}′ supplied to the pulsed load is:

Pₚ′=I_{P}′V₂′D, (18)

Combining equations (17) and (18) yields:

P_{P}′=I₂′V₂′D (19)

When an external current limited supply such as a battery or USB port is used, a circuit according to an embodiment of the invention can be evaluated based on including the storage device 114 in FIG. 4, and further assuming that I₁ and 1₂ are constant and C_{storage} 412 is charged to a steady state voltage.

A practical storage capacitor will likely have an associated ESR, represented as R_{storage} 410 in FIG. 4. If this ESR 410 is large, then the associated power loss may overwhelm the potential advantage of a storage device 114. Power is lost in the ESR 410 of the storage device 114 due to I²R thermal loss during the charging and discharging cycles of the storage capacitor 412. The capacitor 412 will be discharged during the current pulse of duty cycle D, and charged during duty cycle 1−D. The charge current is I₂ for duty cycle 1−D, and the discharge current is I_{P}−I₂ for the fractional duration D. The power loss P_{ESR} due to the ESR of the storage capacitor is:

P_{ESR}=I₂²R_{storage}(1−D)+(I_{P}−I₂)²R_{storage}D (20)

Again using equations (8) or (24), this can be written and further simplified as shown in (20a)-(20h) and (21) :

P_{ESR}=I₂²R_{storage}(1−D)+(I₂/D−I₂)²R_{storage}D (20a)

P_{ESR}=I₂²R_{storage}(1−D)+[I₂(1/D−1)]²R_{storage}D (20b)

P_{ESR}=I₂²R_{storage}(1−D)+I₂²(1/D−1)²R_{storage}D (20c)

P_{ESR}=I₂²R_{storage}(1−D)+I₂²(1/D²−2/D+1)R_{storage}D (20d)

P_{ESR}=I²R_{storage}(1−D)+I₂²(1/D−2+D)R_{storage} (20e)

P_{ESR}=I₂²R_{storage}[(1−D)+(1/D−2+D)] (20f)

P_{ESR}=I₂²R_{storage}[1−D+1/D−2+D] (20g)

P_{ESR}=I₂²R_{storage}(1/D−1) (20h)

P_{ESR}=I₂²R_{storage}(1−D)/D (21)

The power P_{P} provided to the pulsed load is the power supplied by the converter minus the power dissipated by the ESR of the storage capacitor:

P_{P}=I₂V₂−P_{ESR} (22)

Assuming the storage capacitor C_{storage} is large, then V₂ will be essentially constant and analyzed as such. This is a reasonable approximation because many implementations will require a minimal droop in V₂ for proper operation of the load. Given a net charge balance, the integrated charge current I₂ from the converter for duration 1−D plus the integrated current I₂ supplied by the converter to the load for duration D equals the integrated load current I_{P} for duration D, thus:

I₂(1−D)+I₂D=I_{P}D, or equivalently I₂=I_{P}D (23)

Solving for I_{P} in equation (23) above results in:

Iₚ=I₂/D (24)

Because D is less than unity, this shows that the pulsed load current is greater than the current supplied by the converter by a factor of 1/D. This allows the pulsed LED currents to be greater than can be supplied directly by the power source. Combining equations (21) and (22) yields:

P_{P}=I₂V₂−I₂²R_{storage}(1−D)/D (25)

For the power supplied to the load for the subject circuit to be greater with the storage device 114 than without, the pulsed power P_{P} supplied to the load 408 must be greater than the pulsed power P_{P}′:

P_{P}≧P_{P}′, or equivalently, I₂V₂−I₂²R_{storage}(1−D)/D≧I₂′V₂′D (26)

For a fair comparison, the following may be assumed to be true:

V₂=V₂′ and I₂=I₂′ (26a)

Solving the previous inequality in (26) using the equalities in (26a) results in:

I₂V₂−I₂²R_{storage}(1−D)/D≧I₂V₂D (26b)

V₂−I₂R_{storage}(1−D)/D≧V₂D (26c)

V₂−V₂D≧I₂R_{storage}(1−D)/D (26d)

V₂(1−D)≧I₂R_{storage}(1−D)/D (26e)

V₂≧I₂R_{storage}/D (26f)

DV₂/I₂≧R_{storage} (26g)

R_{storage}≦DV₂/I₂ (26h)

R_{storage}≦(V₂/I₂)D (27)

Thus when the equation (27) is true, the power available to the load 408 is greater with the storage device 114 than without.

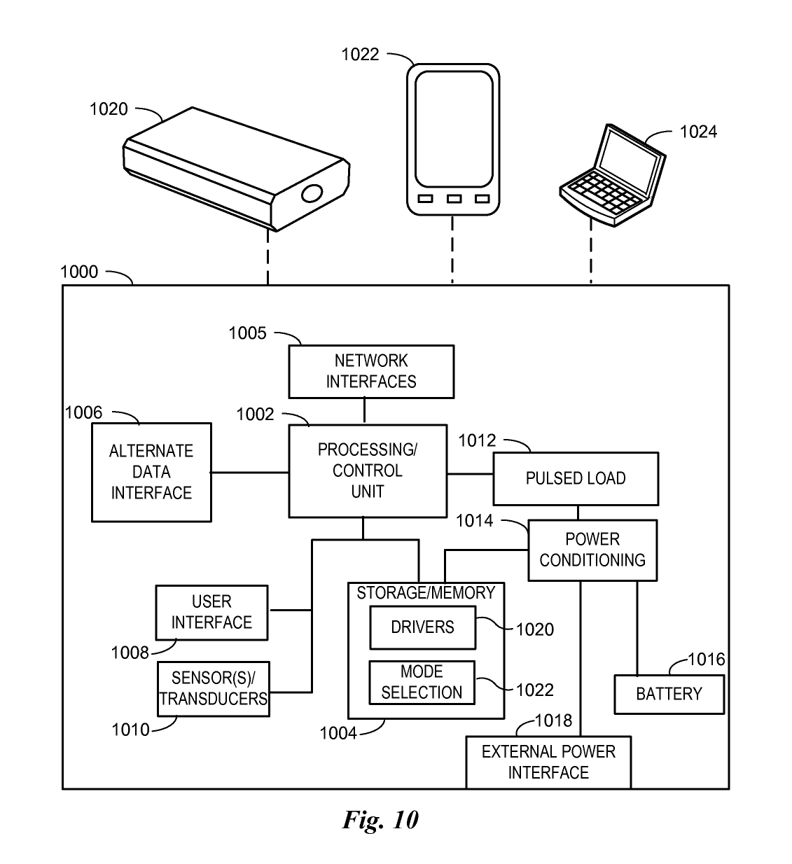

Many types of apparatuses may utilize a power management system as described herein. Users are increasingly using mobile devices on a regular basis. In reference now to FIG. 10, an example embodiment is illustrated of a representative mobile apparatus 1000 capable of carrying out operations in accordance with example embodiments of the invention. Those skilled in the art will appreciate that the example apparatus 1000 is merely representative of general functions that may be associated with such devices, and also that fixed computing systems similarly include computing circuitry to perform such operations.

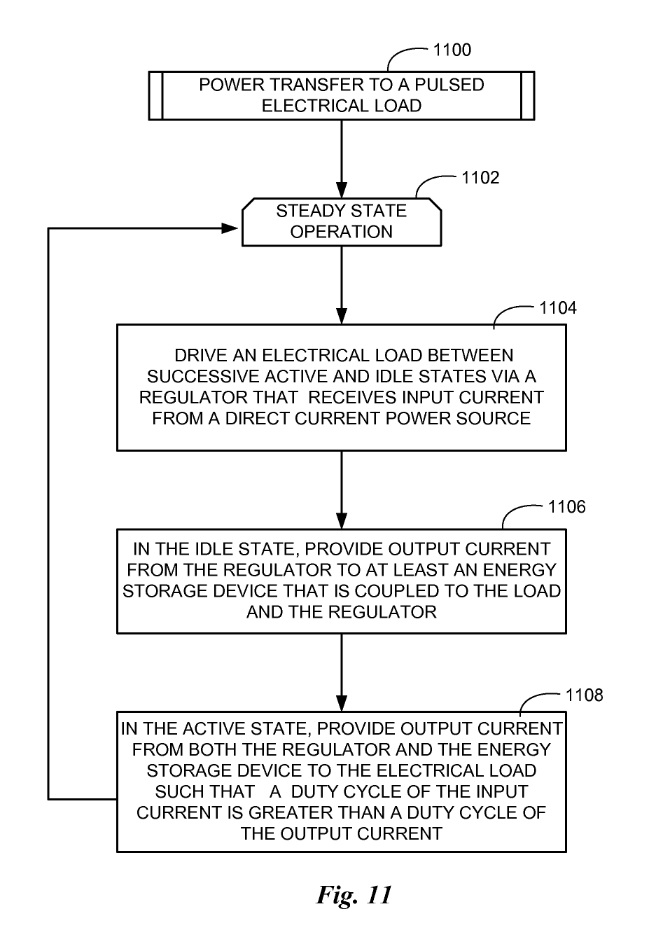

The apparatus 1000 may include, for example, a projector 1020 (e.g., portable universal serial bus projector, self-contained pico projector), mobile phone 1022, mobile communication device, mobile computer, laptop computer 1024, desk top computer, phone device, video phone, conference phone, television apparatus, digital video recorder (DVR), set-top box (STB), radio apparatus, audio/video player, game device, positioning device, digital camera/camcorder, and/or the like, or any combination thereof. The apparatus 1000 may include features of the arrangements 100, 400, 500, 600, 800 and/or 900 as shown and described in relation to FIGS. 1, 4, 5, 6, 8, and 9. Further, apparatus 1000 may be capable of performing functions such as described below relative to FIG. 11.

The processing unit 1002 controls the basic functions of the apparatus 1000. Those functions associated may be included as instructions stored in a program storage/memory 1004. In an example embodiment of the invention, the program modules associated with the storage/memory 1004 are stored in non-volatile electrically-erasable, programmable read-only memory (EEPROM), flash read-only memory (ROM), hard-drive, etc. so that the information is not lost upon power down of the mobile apparatus. The relevant software for carrying out operations in accordance with the present invention may also be provided via computer program product, computer-readable medium, and/or be transmitted to the mobile apparatus 1000 via data signals (e.g., downloaded electronically via one or more networks, such as the Internet and intermediate wireless networks).

The mobile apparatus 1000 may include hardware and software components coupled to the processing/control unit 1002. The mobile apparatus 1000 may include one or more network interfaces 1005 for maintaining any combination of wired or wireless data connections via any combination of mobile service provider networks, local networks, and public networks such as the Internet and the Public Switched Telephone Network (PSTN).

The mobile apparatus 1000 may also include an alternate network/data interface 1006 coupled to the processing/control unit 1002. The alternate data interface 1006 may include the ability to communicate via secondary data paths using any manner of data transmission medium, including wired and wireless mediums. Examples of alternate data interfaces 1016 include USB, Bluetooth, RFID, Ethernet, 1002.11 Wi-Fi, IRDA, Ultra Wide Band, WiBree, GPS, etc. These alternate interfaces 1006 may also be capable of communicating via cables, networks, and/or peer-to-peer communications links. These alternate interfaces 1006 may also be capable of providing power to the apparatus 1000, such as via USB.

The processor 1002 is also coupled to user-interface hardware 1008 associated with the mobile apparatus 1000. The user-interface 1008 of the mobile terminal may include a display 1020, such as a liquid crystal display (LCD) device. The user-interface hardware 1008 also may include a transducer, such as an input device capable of receiving user inputs. A variety of user-interface hardware/software may be included in the interface 1008, such as keypads, speakers, microphones, voice commands, switches, touch pad/screen, pointing devices, trackball, joystick, vibration generators, lights, accelerometers, etc. These and other user-interface components are coupled to the processor 1002 as is known in the art.

The apparatus 1000 may include sensors/transducers 1010 that are part of or independent of the user interface hardware 1008. Such sensors 1010 may be capable of measuring local conditions (e.g., ambient light, location, temperature, acceleration, orientation, proximity, etc.) without necessarily requiring interacting with a user. Such sensors/transducers 1010 may also be capable of producing media (e.g., text, still pictures, video, sound, etc).

The apparatus 1000 further includes a pulsed load 1012, such as a sequential color imaging device as described above. The load 1012 may be the primary functional component of the apparatus 1000, e.g., the load 1012 may consume the substantial majority of power required by the apparatus 1000. This may be the case, for example, where the apparatus 1000 is configured as a pico projector peripheral device and the load 1012 includes an illumination device.

A power conditioning component 1014 provides a pulsed current to the load 1012. The current ultimately originates from one or more power sources. Example power sources shown here include a battery 1016 and an external power interface 1018. The external power interface 1018 may be a dedicated port, or may be part of or included in a data interface 1005, 1006 (e.g., USB, power over Ethernet). Generally, the power conditioning component 1014 may include circuitry that draws current from one or more sources 1016, 1018 at a higher duty cycle than is applied to the load 1012. In one example, the component 1014 may be designed so that the current drawn from the one or more sources 1016, 1018 approximates a constant load, e.g., a peak to peak variation of about 30% of the RMS or average value of the time varying current.

The program storage/memory 1004 may include operating systems for carrying out functions and applications associated with functions on the mobile apparatus 1000. The program storage 1004 may include one or more of read-only memory (ROM), flash ROM, programmable and/or erasable ROM, random access memory (RAM), subscriber interface module (SIM), wireless interface module (WIM), smart card, hard drive, computer program product, and removable memory device.

The storage/memory 1004 may also include one or more software drivers 1020 for providing software control of the pulsed load device 1012. The software driver 1020 may include any combination of operating system drivers, middleware, hardware abstraction layers, protocol stacks, and other software that facilitates accessing and interface with the device 1012 and associated hardware. The storage/memory 1004 of the mobile apparatus 1000 may also include specialized software modules for performing functions according to example embodiments of the present invention.

For example, the program storage/memory 1004 may include a mode selection module 1022 that enables manual or automatic changing of modes related to a pulsed imaging device 1012. For example, a user may enable, via the module 1022, an automatic mode selection that enters a reduced gamut/increased brightness mode based on ambient light detected via sensors 1010. In other arrangements, the user may manually select, via the module 1022, a grayscale mode for near maximum brightness based on particular content to be displayed (e.g., a presentation with black and white text/drawings). Particular modes selected via the module 1022 may cause a corresponding change in power consumed via the load device 1012. In such a case, the power conditioning circuit 1014 may include facilities (e.g., feedback circuits) for tailoring the consumption of power to maximize power transfer efficiency from the one or more power sources 1016, 1018.

The mobile apparatus 1000 of FIG. 10 is provided as a representative example of a computing environment in which the principles of the present invention may be applied. From the description provided herein, those skilled in the art will appreciate that the present invention is equally applicable in a variety of other currently known and future mobile and landline computing environments. For example, desktop and server computing devices similarly include a processor, memory, a user interface, and data communication circuitry. Thus, the present invention is applicable in any known computing structure utilizing a pulsed electrical load.

In reference now to FIG. 11, a flowchart illustrates a procedure 1100 for power transfer to a pulsed electrical load according to an example embodiment of the invention. The procedure involves a continuous process that occurs during steady state operation 1102 of an apparatus. An electrical load is repeatedly driven 1104 between successive active and idle states via a regulator, e.g., a device such as a voltage boost converter that includes a switched mode power supply. The regulator receives input current from a direct current power source, e.g., a battery or external power interface. Output current from the regulator is provided 1106 to at least an energy storage device in the idle states of the electrical load. The energy storage device is coupled to the load and the regulator. Output current is provided 1108 from both the regulator and the energy storage device to the electrical load in the active states of the electrical load, such that a duty cycle of the input current is greater than a duty cycle of the output current. This increase in duty cycle may be obtained, e.g., via selection of a storage capacity of the energy storage device.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

1. An apparatus comprising:
a regulator comprising: a) a switched mode power supply; b) a power input capable of being coupled to receive input current from a direct current power source; and c) a power output capable of being coupled to an electrical load that draws pulsed current from the regulator; and
an energy storage device coupled to the power output of the regulator, wherein a storage capacity of the energy storage device is selected so that a duty cycle of the input current is greater than a duty cycle of the pulsed current.

2. The apparatus of claim 1, wherein the storage capacity of the energy storage device is selected so that the current duty cycle of the direct current power source approximates a constant current draw.

3. The apparatus of claim 1, further comprising a feedback circuit coupled at least to the power input, wherein the feedback circuit modifies a current drawn by the electrical load based on a determination that a duty cycle of the direct current power source meets a predefined threshold.

4. The apparatus of claim 3, wherein the feedback circuit increases the current drawn by the electrical load based on a determination that the current duty cycle of the direct current power source falls below a predefined threshold.

5. The apparatus of claim 4, wherein the feedback circuit increases the current drawn by the electrical load by increasing the duty cycle of the pulsed current.

6. The apparatus of claim 4, wherein the feedback circuit increases the current drawn by the electrical load by increasing a peak current drawn by the electrical load.

7. (canceled)

8. The apparatus of claim 1, further comprising a protection circuit that limits maximum energy storage of the energy storage device.

9. The apparatus of claim 1, wherein the electrical load comprises a driver for one or more pulsed light emitting diodes.

10. The apparatus of claim 1, wherein the regulator comprises a DC-to-DC voltage boost converter, and wherein the energy storage device comprises a capacitor that is selected to have an equivalent series resistance less than a product of an internal resistance of the power source and a voltage gain of the DC-to-DC voltage boost converter squared.

11-12. (canceled)

13. The apparatus of claim 1, wherein the energy storage device comprises a capacitor, and wherein the capacitor is selected to have an equivalent series resistance less than an internal resistance of the direct current power source.

14. (canceled)

15. A method comprising:
repeatedly driving an electrical load between successive active and idle states via a regulator that comprises a switched mode power supply, wherein the regulator receives input current from a direct current power source;
providing output current from the regulator to at least an energy storage device in the idle states of the electrical load, wherein the energy storage device is coupled to the load and the regulator; and
providing output current from both the regulator and the energy storage device to the electrical load in the active states of the electrical load, wherein a storage capacity of the energy storage device is selected so that a duty cycle of the input current is greater than a duty cycle of the output current.

16. The method of claim 15, wherein the storage capacity of the energy storage device is selected so that the duty cycle of the input current approximates a constant current draw.

17. The method of claim 15, further comprising determining that the duty cycle of the input current meets a predefined threshold, and modifying the current of the electrical load in the active states in response thereto.

18-19. (canceled)

20. The method of claim 15, further comprising determining that the duty cycle of the input current meets a predefined threshold, and modifying the input current in response thereto.

21. An apparatus comprising:
one or more driver circuits configured to provide pulsed on and off current to light emitting diodes according to an output duty cycle;
a switched mode regulator capable of receiving input current from a direct current power source and comprising a power output coupled to the one or more driver circuits to provide the pulsed on and off current; and
an energy storage device coupled to the power output of the regulator so that the energy storage device stores energy during at least an idle state of the output duty cycle, wherein a storage capacity of the energy storage device is selected so that a duty cycle of the input current is greater than the output duty cycle.

22. The apparatus of claim 21, wherein the storage capacity of the energy storage device is selected so that the duty cycle of the input current approximates a constant current draw.

23. The apparatus of claim 21, further comprising a feedback circuit coupled to detect the duty cycle of the input current, wherein the feedback circuit modifies the current drawn by the driver circuits based on a determination that the duty cycle of the input current meets a predefined threshold.

24. (canceled)

25. The apparatus of claim 21, further comprising a feedback circuit coupled to detect the duty cycle of the input current, wherein the feedback circuit decreases the input current based on a determination that the current duty cycle of the power source falls below a predefined threshold.

26. The apparatus of claim 21, wherein the energy storage device comprises a capacitor, and wherein the capacitor is selected to have an equivalent series resistance less than an internal resistance of the direct current power source.

27. The apparatus of claim 21, wherein the regulator comprises a DC-to-DC voltage boost converter, and wherein the energy storage device comprises a capacitor that is selected to have an equivalent series resistance less than a product of an internal resistance of the power source and a voltage gain of the DC-to-DC voltage boost converter squared.

28. (canceled)
